(19) United States
(12) Patent Application Publication
(10) Pub. No.: US 2010/0191616 A1
(43) Pub. Date: Jul. 29, 2010

(54) Software method and system to enable automatic, real-time extraction of item price and availability from a supplier catalog during a buyer's electronic procurement shopping process

(76) Inventors: Gary Charles Berkowitz, Centennial, CO (US); Charles Christopher Wurtz, Los Alamos, NM (US)

Correspondence Address: Gary C Berkowitz, 7778 S. Poplar Way, Centennial, CO, 80112, US

(21) Appl. No.: 12/218,842

(22) Filed: Jul. 19, 2008

Related U.S. Application Data
(60) Provisional application No. 60/961,167, filed on Jul. 19, 2007.

(51) Int. Cl. G06Q 30/00

(52) U.S. Cl. 705/27

(57) ABSTRACT

The present invention, termed the Interactive Organic Agent (IOA), augments electronic procurement shopping software with functionality that enables the purchasing organization to capture, in real-time, any changes in supplier item price and availability, as the buyer (user) is shopping or browsing the buyer-side remote catalog index. In particular, as the buyer is viewing remote-catalog pages of items that have been selected as the result of a search, or simply via browsing, the IOA automatically, without any required user action, makes a direct connection to the live supplier online site(s) that correspond to the items being viewed, and then retrieves the latest price & availability data. Via the use of knowledge-capture and artificial intelligence (including an Organic Profile Language) to trigger an operation termed “Organic Punch-out”, the IOA generates a background connection to a live vendor site only when, and only long enough as, necessary to retrieve updated item information, without any direct action by the buyer.

### CROSS-REFERENCE TO RELATED APPLICATIONS

This application claims benefit of, and incorporates by reference in whole, the provisional application:
A Software Method and System to Enable Automatic, Real-Time Extraction of Item Price and Availability from a Supplier Catalog During a Buyer's Electronic Procurement Shopping Process
Application No. 60/961,167, Filing Date Jul. 19, 2007,
Inventors: Gary C. Berkowitz & Charles C. Wurtz.

This application claims benefit of the prior filed co-pending applications:
Knowledge-based e-catalog procurement system and method
application Ser. No. 10/215,109 Filing Date Aug. 8, 2002
Inventors: Gary C. Berkowitz, D. Serebrennikov, B. M. Roe, C. C. Wurtz
Virtual Supercomputer
application Ser. No. 10/821,582 Filing Date Apr. 9, 2004
Inventors: Gary C. Berkowitz & Charles C. Wurtz.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

This application incorporates by reference, in whole, the material contained in the computer program listing appendix submitted with this application on two (2) identical copies of a CD-R (read only) compact disc, containing one (1) file, named PunchThruQuery Code Implementation—USPTO ASCII.txt.

### BACKGROUND OF THE INVENTION

1. Field of the Invention

The present invention is directed toward the field of electronic procurement systems. More specifically, the technology described in this patent application relates to a system and method to enable the automatic, real-time extraction of price and availability of particular supplier electronic-catalog items during the buyer's shopping experience.

2. Description of the Related Art

A pending utility patent application (Knowledge-based e-catalog procurement system and method, U.S. Ser. No. 10/215,109) provides a solution to one of the fundamental problems of business-to-business (B2B) Internet commerce, which is the ability to electronically shop a heterogeneous mix of vendors, or suppliers, whose catalog contents appear in a variety of formats, and further, the ability of an organization to capture and store the shopping patterns and choices of its buyers (shoppers), and to make this evolving knowledge available to the entire organization. The IntelleCat system is part of the method, termed Organic Computing, which forms the foundation of an array of inventions that are the subject of this and related applications.

Unlike any other known e-procurement method, the IntelleCat system, in its current embodiment, creates a dynamic, evolving, network-enabled Remote Index of a heterogeneous mix of supplier catalog items, that may exist in a variety of electronic formats, or not in electronic format at all. This index allows a buyer (that is, a user in the purchasing organization) to browse, search and select items from a fast, secure buyer-side data store, which spans multiple suppliers and formats, and contains virtual images (data replicas) of every item available across these multiple vendor sites, without the need for being directly connected, in most cases, to any supplier (vendor) electronic (web) site. This direct connection, often termed “punch-out”, is kept to a minimum in the IntelleCat system.

The remote index evolves via the actions of three separate, but interrelated, inventions. The first, termed the Autonomous Organic Agent, and the subject of a separate provisional patent application, continually operates in the background, crawling supplier websites to extract elementary information pertaining to structure, format, and access rules for a particular site. From this information, it builds a template for that particular supplier (vendor), and then incorporates the template into the remote index, as a foundation for further refinement and optimization of the buyer-supplier relationship.

A second invention, termed the Assisted Organic Agent (AOA), which is also the subject of a separate provisional patent application, works in the background to continually crawl supplier websites that have already been characterized by the Autonomous Organic Agent, and gathers updates on the price, availability, and other meta-data, for items in supplier catalogs. This information, too, is then incorporated into the remote index. The Assisted Organic Agent also captures and stores into the remote index the buying patterns of the purchasing organization, and thus maintains an evolving profile of the “intentionality” of the purchasing organization, which enables the software to optimize the relationship between buyer and supplier, without external human intervention.

A third invention, and the subject of the present application, is termed the IntelleCat Interactive Organic Agent (IOA), in its preferred embodiment. The IOA augments IntelleCat with functionality that enables the purchasing organization to capture, in real-time, any changes in item price and availability, as the buyer (user) is shopping or browsing the buyer-side catalog index. In particular, as the buyer (user) is viewing remote-catalog pages of items that have been selected as the result of a search, or simply via browsing, the IOA automatically, without any required user action, makes a direct connection to the live supplier online site(s) that correspond to the items being viewed, and retrieves the latest price & availability data, which is then handed off to the AOA for incorporation into the remote index.

There are no known current technologies that provide this functionality.

### BRIEF SUMMARY OF THE INVENTION

All web-based or other catalogs that are available online are designed to enable human users to access and “shop” the catalog. What the present invention accomplishes is to minimize the interaction between the buyer and the supplier (vendor), via the use of knowledge-capture and artificial intelligence (including an Organic Profile Language) to trigger operations termed “Organic Punch-out”, or “Punch-Through Queries”, that generate a background connection to a live vendor site only when, and only long enough as, necessary to retrieve updated item information, without any direct action by the buyer. In particular, four key functional aspects of the IOA are:
It implements a method of automatically extracting in real-time any updated information on price and availability of particular vendor items (SKUs) from online supplier catalogs, which is then passed to the Assisted Organic Agent for maintaining the dynamic remote index.
The invention also allows this punch-through procedure to be disenabled should contractual negotiations between buyer and supplier generate a mutual agreement that the actions of the IOA would be problematic from a commercial perspective.
The IOA allows the separation of current pricing data from current availability data in real-time, such that they are not linked, and therefore availability can be given a higher priority than pricing, and vice-versa.
This differentiation of price and availability enables the electronic procurement process across multiple vendors to balance the priorities of obtaining price and availability data, thus allowing the purchasing organization to implement the most efficient supply-chain management, and the most effective use of electronic procurement resources.

### BRIEF DESCRIPTION OF THE DRAWINGS

FIG. 1 shows a screen image of the operation of the IOA as it retrieves live price and availability data for the previously found Internet Punch-out SKUs from the supplier's Internet Punch-out website.

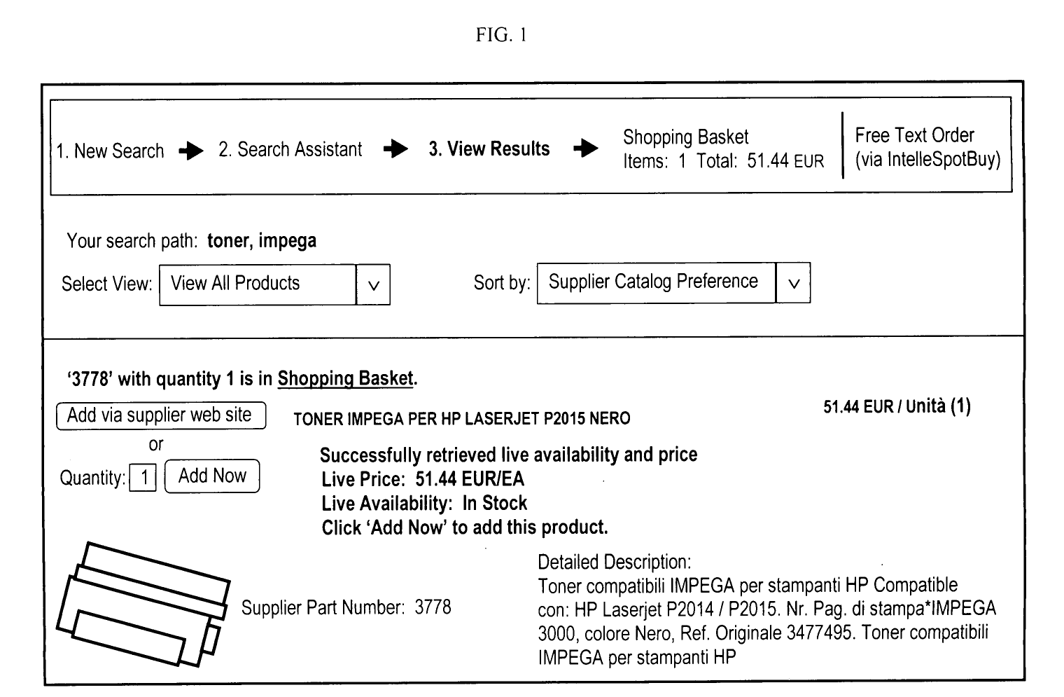

### DETAILED DESCRIPTION OF THE INVENTION

The detailed description of the present invention also incorporates by reference, in whole, the computer program listing appendix submitted with this application on duplicate CD-R discs, as referenced at the beginning of the Specification.

This section, along with the code implementation, provides a detailed functional and technical description of the product named IntelleCat Interactive Organic Agent (IOA), which is the preferred embodiment of the present invention, and is a component of a product named IntelleCat, a patent-pending knowledge-based e-catalog procurement system (Knowledge-based e-catalog procurement system and method, U.S. application Ser. No. 10/215,109).

### DEFINITIONS

1) Assisted Organic Agent. Also known as mini-crawls. This agent enhances the data surrounding a ‘new’ item that a user has found to be useful, and/or expand the known area after a ‘lite’ initial crawl.
2) Autonomous Organic Agent: Also known as the base crawl, this is the first crawl that is run against a site.
3) Interactive Organic Agent. Also known as Punch-Thru Query (PTQ), this is the type of interaction where the user is looking for something, but is unaware that IntelleCat is ‘following along’ behind the scenes and remembering what is found.

### Crawling:

When crawling a site, links are categorized into three categories (and their corresponding action items):
1) A link that leads to a page. In this case, the link is expanded.
2) A link that is a page. If the link is an item page, an attempt is made to parse the page.
3) A link that does not lead to a page. The link is excluded.

Requirement: For large sites, the queue of links to follow can become huge. In order to not use up memory unnecessarily, this queue is persisted to disk. This also helps make crawls restartable, which is a requirement for both the base crawl and subsequent mini-crawls. As time goes on, there will be less difference between the base crawl and subsequent mini-crawls.

### Indexing

The index includes both items, and other meta-data about the site. For example, a complete list of categories that are meaningful for a given site.

When a page is parsed and then an item are indexed, the following fields are set during indexing:
1) Title
2) Category path
3) Description (long description)
4) Price
5) UOM
6) Image
7) Availability

A unique key for a given index is determined. Typically it is defined by the <part number>, but in some cases it is <part number>+<UOM>.

### The Improved Base Crawl:

A new approach to base crawls is that the site crawl just gathers category information but very little other data. This enables PTQ to know more about what it's likely to find on a given site, and then dynamically search it in response to a specific request.

### Profile Parameters:

The following list contains a number of fields that can be defined on a per-profile basis, although they may default to standard values in some eases:
1) Wait-time value: This shows the ‘typical’ wait time to get results for a query from a given site. This lets the UI decide whether or not it should wait for results from a given PTQ before displaying total results. Question: How do we get a statistically accurate value for this? Also, it will likely be different between test and production.
2). Crawl depth.
3) FTP values, if any.

### Crawl Threading:

Some sites get confused if they are being crawled by more than one thread. If this is the case for a site, the number of crawling threads is set to just one, and the crawler then goes back and access the URLs returned by the crawling thread from any number of accessor threads.

Timeouts are in the PTQ code for several reasons:
1) The site could be down.
2) The interne connection is down
3) Other failures, especially if the network fails in the middle of servicing a PTQ request.

In addition to bona-fide timeouts, other types of errors can occur. For example, each site will have one or more error pages, sometimes with useful data contained therein. Another function of the PTQ drive is to punch out to the PO site when there are too many results to display. This function then runs the site's search engine, using the current top in IntelleSearch, and takes the user to the search results page for browsing.

### Regional Sites

Some punch-out sites are ‘regional’, meaning that there is one site, but that responds differently depending on who comes in. For example, Sigma US and Sigma UK are actually the same site.

This ‘regionality’ doesn't necessarily have to be related to different countries; it could be for different geographic regions within the same country.

What is claimed is:

1. A software method for enabling an electronic procurement buyer to capture, in real-time, any changes in item price and availability, as the buyer is viewing remote-catalog pages of items that have been selected as the result of a search, or simply via browsing, such that the buyer, without any required buyer action, is directly connected to the live supplier online site(s) that correspond to the items being viewed, and the latest price & availability data are retrieved automatically, and the data is then handed off to the Assisted Organic Agent for incorporation into the remote index.

2. A computer system comprising:
a first storage device for storing a plurality of previously submitted find-trees;
a processor connected to the first storage device, with the processor configured for:
enabling an electronic procurement buyer to capture, in real-time, any changes in item price and availability, as the buyer is viewing remote-catalog pages of items that have been selected as the result of a search, or simply via browsing, such that the buyer, without any required buyer action, is directly connected to the live supplier online site(s) that correspond to the items being viewed, and the latest price & availability data are retrieved automatically, and the data is then handed off to the Assisted Organic Agent for incorporation into the remote index.
